(19) United States
(12) Patent Application Publication
(10) Pub. No.: US 2016/0299884 A1
(43) Pub. Date: Oct. 13, 2016

(54) TRANSFORMING NATURAL LANGUAGE REQUIREMENT DESCRIPTIONS INTO ANALYSIS MODELS

(71) Applicant: THE UNIVERSITY OF MANCHESTER, Manchester, Greater Manchester (GB)

(72) Inventors: Erol-Valeriu CHIOASCA, Manchester, Greater Manchester (GB); Keletso Joel LETSHOLO, Manchester, Greater Manchester (GB); Liping ZHAO, Manchester, Greater Manchester (GB)

(21) Appl. No.: 15/035,682

(22) PCT Filed: Nov. 11, 2014
(86) PCT No.: PCT/GB2014/053339

§ 371 Date: May 10, 2016

(30) Foreign Application Priority Data
Nov. 11, 2013 (GB) 1319856.9

(51) Int. Cl. G06F 17/27; G06F 17/24; G06F 3/0484

(52) U.S. Cl. CPC G06F 17/2785; G06F 17/271; G06F 17/274; G06F 17/277; G06F 3/04842; G06F 17/248

(57) ABSTRACT

Natural Language Requirement (NLR) descriptions are parsed to generate syntactic verb structures. These structures are matched with a set of pre-defined semantic patterns to form semantic networks of semantic pattern instances. The networks are searched; any missing concepts identified and any incorrect or ambiguous concepts modified or clarified by user interaction. This interaction creates new semantic pattern instances that are used to generate an analysis model represented by a Unified Modelling Language (UML) or Entity-Relationship (ER) diagram, which can then be subsequently used to generate a computer software system.

### FIELD OF THE INVENTION

The present invention concerns a framework and a software implementation for transforming Natural Language Requirement (NLR) descriptions into initial software models (also called analysis models).

### BACKGROUND OF THE INVENTION

Most software development requirements are initially expressed in a natural language before they are translated into analysis models. Such analysis models are represented by a modelling language, such as Entity-Relationship (ER) Diagram and Unified Modelling Language (UML). The translation is typically performed manually, which is time-consuming and error-prone. Also, the quality of the model depends upon the experience and knowledge of the human modeller. Consequently, this process has become a bottleneck in software development.

### SUMMARY OF THE INVENTION

According to a first aspect of the present invention, there is provided a method for transforming Natural Language Requirement descriptions into an analysis model, the method being performed by a computer system and the method comprising:
parsing the Natural Language Requirement descriptions to generate syntactic verb structures;
matching each one of the syntactic verb structures with a pre-defined semantic pattern to thereby identify a matching semantic pair for each of the syntactic verb structures, wherein each pre-defined semantic pattern is from a set of pre-defined semantic patterns based on verb categories;
creating a group of instances comprising a semantic pattern instance for each said matching semantic pair, wherein each semantic pattern instance has elements for words contained in the generated syntactic verb structures;
composing the group of instances into at least one semantic network;
identifying at least one incomplete part of the semantic network;
requesting and receiving additional information to complete the incomplete part of the semantic network;
adding at least one new semantic pattern instance to the semantic network to create a revised semantic network, wherein the new semantic pattern instance is based on the additional information; and
generating an analysis model from the revised semantic network.

According to a second aspect of the present invention there is provided a computer system that in operation performs the method according to the first aspect of the present invention.

According to a third aspect of the present invention there is provided a tangible computer-readable medium storing instructions for performing the method according to the first aspect of the present invention.

According to a fourth aspect of the present invention there is provided a method for transforming Natural Language Requirement descriptions into an analysis model, the method being performed by a computer system and the method comprising:
parsing the Natural Language Requirement descriptions to generate syntactic verb structures;
matching each one of the syntactic verb structures with a pre-defined semantic pattern to thereby identify a matching semantic pair for each of the syntactic verb structures, wherein each pre-defined semantic pattern is from a set of pre-defined semantic patterns based on verb categories;
creating a group of instances comprising a semantic pattern instance for each said matching semantic pair, wherein each semantic pattern instance has elements for words that form the respective verb structure of the instance; and
generating an analysis model from the group of instances.

According to a fifth aspect of the present invention there is provided a computer system that in operation performs the method according to the fourth aspect of the present invention.

According to a sixth aspect of the present invention there is provided a tangible computer-readable medium storing instructions for performing the method according to the fourth aspect of the present invention.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 is a schematic block diagram of a computer system for transforming NLR descriptions, into an analysis model in accordance with an embodiment of the present invention;

FIG. 2 is a conceptual graph for a Sematic Object Model structure CHANGE;

FIG. 3 is a conceptual graph for a Sematic Object Model structure POSSESSION;

FIG. 4 is a conceptual graph for a Sematic Object Model structure COGNITION;

FIG. 5 is a conceptual graph for a Sematic Object Model structure CREATION;

FIG. 6 is a conceptual graph for a Sematic Object Model structure MOTION;

FIG. 7 is a conceptual graph for a Sematic Object Model structure PERCEPTION;

FIG. 8 is a conceptual graph for a Sematic Object Model structure COMMUNICATION;

FIG. 9 is a conceptual graph for a Sematic Object Model structure CONTACT;

FIG. 10 is a conceptual graph for a Sematic Object Model structure STATIVE;

FIG. 11 is a flow diagram of a computer implemented method for transforming NLR descriptions, into an analysis model in accordance with an embodiment of the present invention;

FIG. 12 illustrates two instances of conceptual graphs being combined into a Semantic network; and

FIG. 13 is a meta-model for a Sematic Object Model.

### DETAILED DESCRIPTION OF THE EMBODIMENTS

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

The detailed description set forth below in connection with the appended drawings is intended as a description of presently preferred embodiments of the invention, and is not intended to represent the only forms in which the present invention may be practised. It is to be understood that the same or equivalent functions may be accomplished by different embodiments that are intended to be encompassed within the spirit and scope of the invention. In the drawings, like numerals are used to indicate like elements throughout. Furthermore, terms “comprises,” “comprising,” or any other variation thereof, are intended to cover a non-exclusive inclusion, such that module, circuit, device components, structures and method steps that comprises a list of elements or steps does not include only those elements but may include other elements or steps not expressly listed or inherent to such module, circuit, device components or steps. An element or step proceeded by “comprises . . . a” does not, without more constraints, preclude the existence of additional identical elements or steps that comprises the element or step.

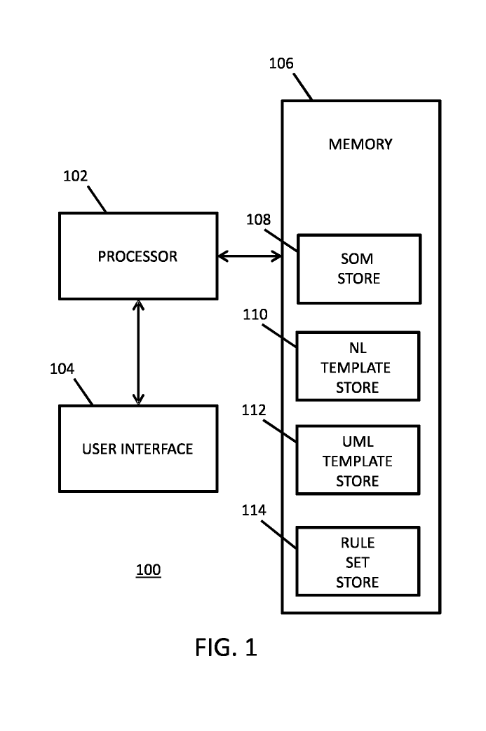

FIG. 1 illustrates a schematic block diagram of a computer system 100 for transforming a NLR descriptions (a specification described in a natural language), into an analysis model in accordance with an embodiment of the present invention. The system 100 can be considered as a computer and includes a processor 102 coupled to both a user interface 104 and a memory module 106. The memory module 106 includes program code for controlling and performing the operation of transforming the NLR descriptions. In this regard, the memory module 106 also includes a Sematic Object Model (SOM) store 108, a Natural Language (NL) template store 110, a UML template store 112 and a rule set store 114 that stores sets of rules as described in this specification.

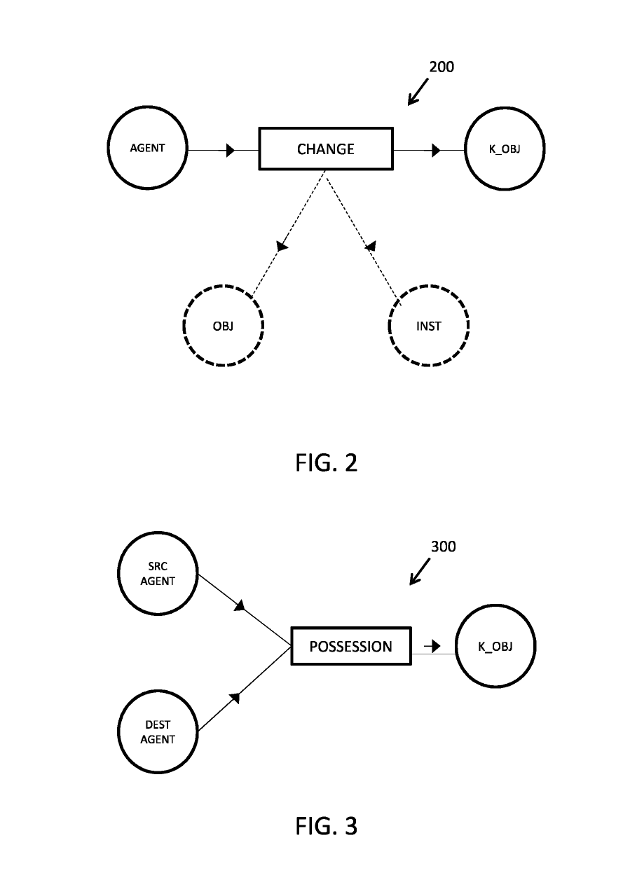

The Sematic Object Model (SOM) store 108 includes representations of a plurality of SOM structures in Backus-Naur Form (BNF) notation. In some embodiments there are nine such structures, In FIG. 2 a conceptual graph 200 for a SOM structure CHANGE associated with a verb category classified as “change” is illustrated. The elements of the conceptual graph 200 are defined as follows: Agent is a group or an individual who interacts with the system in order to change the key object; Change is a transitive verb, which through its sense denotes change; Key object (k_obj) is the object which is the focus of the change process i.e. the object which is changed or otherwise altered; Object (obj) is the replacement of the key object; and Instrument (inst) is a tool that is used as an aid during the change process.

The purpose of the SOM structure CHANGE is to describe the requirements in which an Agent (or a group of agents) cause change to a Key object. There are two general types of change to an Object; replacing one Object with another, or altering the concerned Object. The BNF form for the SOM structure CHANGE is stored in the SOM store 108 as follows:

<CHANGE SOM> ::= <agent> <action> {<obj>} {<inst>}
<action> ::= <transitive_verb> <k_obj>
<transitive_verb> ::= verb.<sense>
<sense> ::= change
<k_obj> ::= <thing>

In FIG. 3 a conceptual graph 300 for a SOM structure POSSESSION associated with a verb category classified as “possession” is illustrated. The elements of the conceptual graph 300 are defined as follows: Source agent (src_agent) is the initial owner of the key object; Destination agent (dst_agent) is the initiator of the action by requesting the temporary or permanent allocation of the key object from the source agent; Possession is a transitive verb, which through its sense denotes possession; and Key object (k_obj) has an ownership that is the focus of the transfer or allocation process.

The purpose of the SOM structure POSSESSION is to define requirements in which the ownership of a key object is transferred between agents, these actions being either temporary (e.g. “loan”) or permanent (e.g. buy). Possession actions are further classified in two categories: static possession (e.g. denoted by verbs such as “to have”, “to own”) and dynamic possession. The former are treated as properties of the agents, while the latter are categorised into two perspectives: the first perspective is that of an agent who owns the resources, i.e. source agent, while the other perspective is of an agent who desires the resource, i.e. destination agent (e.g. seller versus buyer). The BNF form for the SOM structure POSSESSION is stored in the SOM store 108 as follows:

<POSSESSION SOM> ::= <src_agent> <action> <dst_agent>
<action> ::= <transitive_verb> <k_obj>
<transitive_verb> ::= verb.<sense>
<sense> ::= possession
<k_obj> ::= <thing>

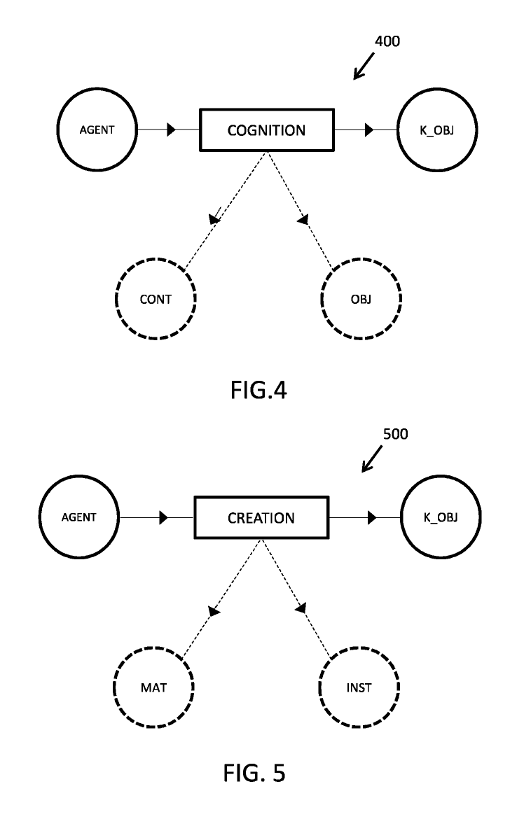

In FIG. 4 a conceptual graph 400 for a SOM structure COGNITION associated with a verb category classified as “cognition” is illustrated. The elements of the conceptual graph 400 are defined as follows: Agent is an element that interacts with the system in order to process in a cognitive way the key object; Cognition is a transitive verb, which through its sense denotes cognition; Key object (k_obj) is the object which is the focus of the cognition process; Container (cont) holds the key object; and Object (obj) is an additional object that is involved in the cognition process together with the key object.

The purpose of the SOM structure COGNITION is to capture requirements within which an agent takes into consideration a key object and the result is an enhancement that contains the key object which is useful In taking further actions or decisions. There are currently two types of cognition processes. The first type is object specialisation, and the second type is the execution of a cognitive process. This is the reason why containers and objects may appear in this SOM. In most cases there is a mutually exclusive relationship between the container and the object i.e. we either find one or the other and not both at the same time. The BNF form for the SOM structure COGNITION is stored in the SOM store 108 as follows:

<COGNITION SOM> ::= <agent> <action> {<cont>} {<obj>}
<action> ::= <transitive_verb> <k_obj>
<transitive_verb> ::= verb.<sense>
<sense> ::= cognition
<k_obj> ::= <thing>

In FIG. 5 a conceptual graph 500 for a SOM structure CREATION associated with a verb category classified as “creation” is illustrated. The elements of the conceptual graph 500 are defined as follows: Agent interacts with the system in order to create the key object; Creation is a transitive verb which through its sense denotes creation; Key object (k_obj) is the object which results from the creation process; Material (mat) is component or substance used to create the key object; and Instrument (inst) is a tool that is used as an aid during the creation process.

The purpose of the SOM structure CREATION is to define requirements in which an agent is described as building a key object from existing data, information, material, or components. The BNF form for the SOM structure CREATION is stored in the SOM store 108 as follows:

<CREATION SOM> ::= <agent> <action> {<mat>} {<inst>}
<action> ::= <transitive_verb> <k_obj>
<transitive_verb> ::= verb.<sense>
<sense> ::= creation
<k_obj> ::= <thing>

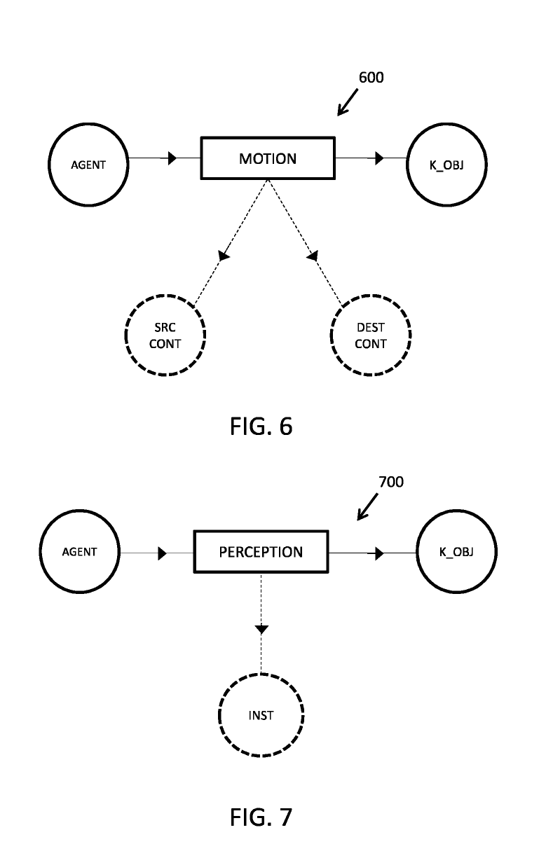

In FIG. 6 a conceptual graph 600 for a SOM structure MOTION associated with a verb category classified as “motion” is illustrated. The elements of the conceptual graph 600 are defined as follows: Agent interacts with the system in order to move the key object from a source container to a destination container; Motion is a transitive verb, which through its sense denotes motion; Key object (k_obj) is the object moved from source to destination; Source Container (src_cont) initially holds the key object; and Destination container (dst_cont) holds the key object after the completion of the motion action.

The purpose of the SOM structure MOTION is to describe requirements in which agents move key objects between containers. The BNF form for the SOM structure MOTION is stored in the SOM store 108 as follows:

<MOTION SOM> ::= <agent> <action> {<src_cont>} {<dst_cont>}
<action> ::= <transitive_verb> <k_obj>
<transitive_verb> ::= verb.<sense>
<sense> ::= motion
<k_obj> ::= <thing>

In FIG. 7 a conceptual graph 700 for a SOM structure PERCEPTION associated with a verb category classified as “perception” is illustrated. The elements of the conceptual graph 700 are defined as follows: Agent interacts with the system in order to determine either properties or the current state of a key object. This agent could be passive i.e. receives notification of any state changes, or active i.e. the agent prompts the monitor to determine the current state of the key object; Perception is a transitive verb, which through its sense denotes perception; Key object (k_obj) is the object whose properties or states, are the focus of the perception process; and Monitor which is usually a physical machine that has the capability of acquiring information about a key object (i.e. observes properties or state changes), either continuously or prompted by the agent.

The purpose of the SOM structure PERCEPTION is to define requirements in which an agent determines properties or states of a key object using a monitor. Usually, the information collected during this process is used for decision making. The perception process can be continuous, or triggered in specific moments. The BNF form for the SOM structure MOTION is stored in the SOM store 108 as follows:

<PERCEPTION SOM> ::= <agent> <action> {<instrument>}
<action> ::= <transitive_verb> <k_obj>
<transitive_verb> ::= verb.<sense>
<sense> ::= perception
<k_obj> ::= <thing>

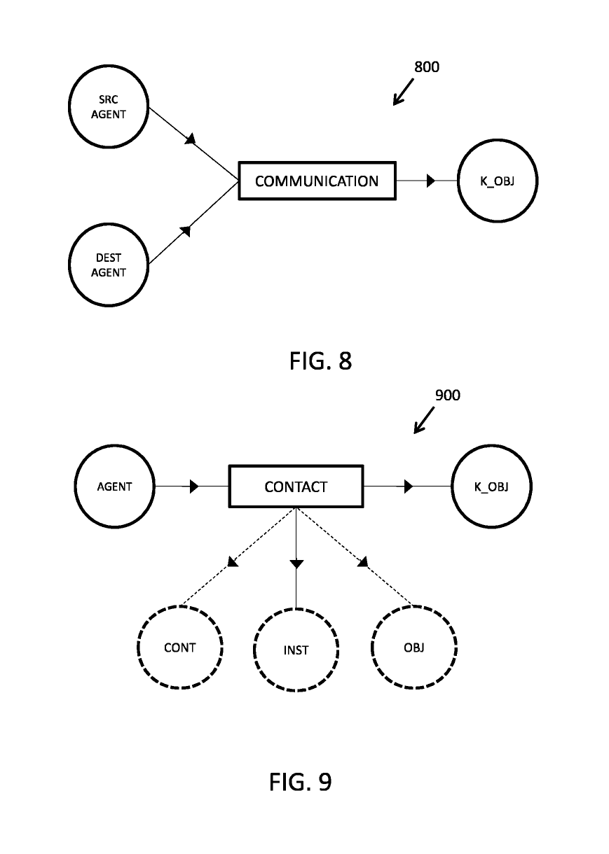

In FIG. 8 a conceptual graph 800 for a SOM structure COMMUNICATION associated with a verb category classified as “communication” is illustrated. The elements of the conceptual graph 800 are defined as follows: Source agent (src_agent) initiates the communication process; Destination agent (dst_agent) is the recipient of the message; Communication is a transitive verb, which through its sense denotes communication; and Key object (k_obj) is the focus of the communication process (i.e. the message).

The purpose of the SOM structure COMMUNICATION is to capture requirements within which agents communicates with each other using the system via a key object. This SOM communicates with each other using the system via a key object. This SOM distinguishes between two types of communication, specifically, direct and indirect communication. Direct communication involves interaction between at least two agents and the key object is the topic of the communication process. Indirect communication occurs when an agent interacts with another agent through a key object. The BNF form for the SOM structure COMMUNICATION is stored in the SOM store 108 as follows:

<COMMUNICATION SOM> ::= <src_agent> <action> <dst_agent>
<action> ::= <transitive_verb> <k_obj>
<transitive_verb> ::= verb.<sense>
<sense> ::= communication
<k_obj> ::= <thing>

In FIG. 9 a conceptual graph 900 for a SOM structure CONTACT associated with a verb category classified as “contact” is illustrated. The elements of the conceptual graph 900 are defined as follows: Agent: interacts with the system in order to initiate the contact process; Contact is a transitive verb, which through its sense denotes contact; Key object (k_obj) is the focus of the contact process; and Instrument (inst): a tool that is used as an aid during the contact process.

The purpose of the SOM structure CONTACT is to capture requirements in which an agent, through a system, has to directly interact with a key object and manipulate it. The BNF form for the SOM structure CONTACT is stored in the SOM store 108 as follows:

<CONTACT SOM> ::= <agent> <action> {<inst>><cont><obj>}
<action> ::= <transitive_verb> <k_obj>
<transitive_verb> ::= verb.<sense>
<sense> ::= contact
<k_obj> ::= <thing>

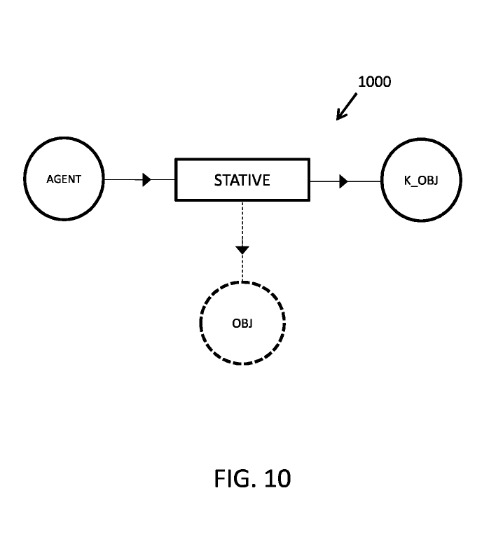

In FIG. 10 a conceptual graph 1000 for a SOM structure STATIVE associated with a verb category classified as “stative” is illustrated. The elements of the conceptual graph 1000 are defined as follows: Agent: is an entity in the system that has some static relationships; Stative is a transitive verb, which through its sense describes static relationships between things; Key object (k_obj) represents the main element involved in a static relationship with an agent.

The purpose of the SOM structure STATIVE is capture requirements that describe static relationships. The BNF form for the SOM structure STATIVE is stored in the SOM store 108 as follows:

<STATIVE SOM> ::= <agent> <action> {< obj>}
<action> ::= <transitive_verb> <k_obj>
<transitive_verb> ::= verb.<sense>
<sense> ::= stative
<k_obj> ::= <thing>

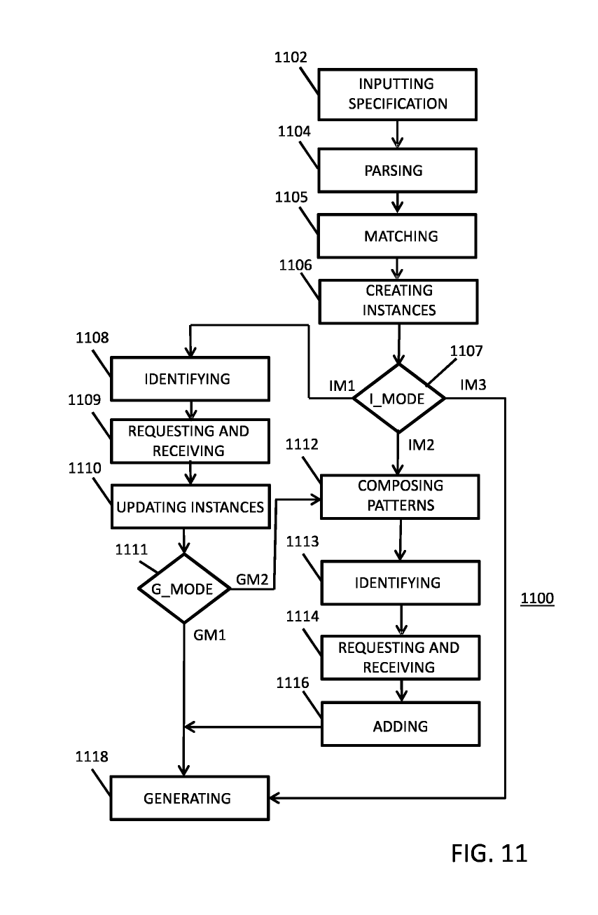

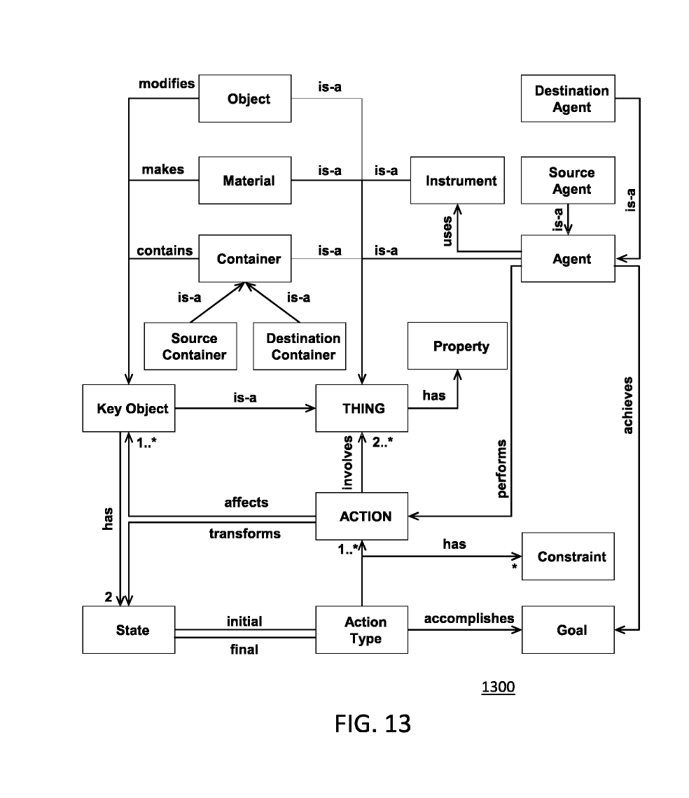

For completeness a meta-model for a Sematic Object Model 1300 is shown in FIG. 13. This model 1300 includes all the Sematic Object Model structures 200 to 1000. Referring to FIG. 11 there is illustrated a flow diagram of a computer implemented method 1100 for transforming a NLR descriptions (a specification described in a natural language) into an analysis model in accordance with an embodiment of the present invention. At an inputting block 1102, the NLR descriptions are input to the system 100 and stored in the memory module 106. The NLR descriptions describe the requirements of at least one software module that is required to be developed. For example, NLR descriptions for a sales web-system may be as follows:

“A Salesperson turns on laptop, brings up the SaleWeb program, and chooses Report Sales Order from menu. Salesperson enters name, employee number, and ID. Sales Order checks to see if name, number and ID are valid. Salesperson enters customer name and address on sales order form. Salesperson checks customer information to find customer status. CustInfo checks Accounting to determine customer status. Accounting approves customer information and supplies customer credit limit. CustInfo accepts customer entry on Sales Order. Salesperson enters first item being ordered on sales order form. Salesperson enters second item being ordered, etc. When all items have been entered Items ordered are checked to determine availability and to check pricing. Items ordered checks with Inventory to determine availability and to check pricing. Inventory supplies all availability dates (when it can ship), approves prices, adds shipping and taxes, and totals order. Complete order appears on salesperson's screen. Salesperson can print order, check with customer, etc. Salesperson submits the approved Sales Order. Sales Order is submitted to Accounting and Inventory.”

At parsing block 1104, the processor 102 parses the NLR descriptions to generate syntactic verb structures. In one embodiment the parsing is based on the Stanford parsing approach as described in the document “D. Klein and C. D. Manning. Accurate unlexicalized parsing. In Proceedings of the 41st Annual Meeting on Association for Computational Linguistics-Volume 1, pages 423-430. Association for Computational Linguistics, 2003.” The parsing performs four tasks: (1) identifying and assigning part-of-speech (POS) tags to the words in text (e.g., noun, verb, adjective, etc); (2) creating grammatical relations or type dependencies among elements in a sentence; (3) extracting dependencies specific for NLR processing; (4) assigning a unique identifier to each word in the text for traceability purposes.

The POS tags are assigned in four sub-stages which are: (a) segmenting the NLR descriptions word and sentence units; (b) initially assigning words of the NLR descriptions to POS-tags based on a lexicon and a set of rules; (c) revising the initial POS tags based on rule driven contextual POS assignments; and (d) calculating the probability of each potential sequence of tags, and the sequence with the highest probability is chosen. Some of the basic word tags include: NN—singular common noun, neutral for number (e.g. sheep, cod); NNS—plural common noun (e.g. books, girls); NNP—singular proper noun (e.g. London, Erol, Joel); VB—base form of lexical verb (e.g. give, work); and VBD—past tense of lexical verb (e.g. gave, worked). The singular and plural noun tags determine the cardinality of an element. For instance, NN and NNP tags denote a single element, while NNS and NNPS denote more than one element. Furthermore, he created grammatical relations are type dependencies such as:
dobj (verb, noun): This defines the direct object relation of a verb for the active voice. “The librarian brings books from shelf” dobj (brings, books);
subj (verb, noun): This defines a nominal subject of the verb. In this relation, the verb serves as a link to a dobj. “The librarian brings books from shelf” nsubj (brings, librarian); and
prep (verb, noun): This defines a prepositional modifier of a verb. The verb serves as a link to the dobj, depending on the adjective, the noun in this relation may denote a source or destination object. “The librarian brings books from shelf” prep_from (brings, shelf).

In addition to the above, the parsing at block 1104 also identifies lexical patterns and lexical labels within the syntactic verb structures. However, it will be understood that other parsing techniques may be applied.

At a matching block 1105 each one of the syntactic verb structures are matched with a pre-defined semantic pattern (SOM structure) to thereby identify a matching semantic pair. Matching will select the first tense of a verb from a dictionary and map it onto a corresponding SOM structure. Thus a matching semantic pair is created for each of the syntactic verb structures and typically includes use of the verb categories to identify a matching semantic pattern for each of the syntactic verb structures. This matching is primarily achieved by reference to the Sematic Object Model (SOM) store 108 that includes SOMs that model each pre-defined semantic pattern. All the pre-defined semantic patterns form a set of pre-defined semantic patterns that consist of the nine SOM structures illustrated in FIGS. 2 to 10 Each of the pre-defined semantic patterns is uniquely identified by a verb category, which is defined in the lexical database WordNet™. The subset based on the WordNet™ categories is illustrated in table 1.

TABLE 1
Listing of verb categories according to the WordNet ™ classification
and corresponding SOM structures derived from these categories.

| Verb Category | Verbs | SOM STRUCTURE |
|---|---|---|
| change | size, change, brightening, etc. | CHANGE |
| possession | buying, selling, renting, etc. | POSSESSION |
| cognition | thinking, understanding, etc. | COGNITION |
| creation | sculpting, paining, making, etc. | CREATION |
| motion | walking, jumping, driving, etc. | MOTION |
| perception | seeing, hearing, feeling, etc. | PERCEPTION |
| communication | telling, asking, ordering, etc. | COMMUNICATION |
| contact | touching, hitting, tying, etc. | CONTACT |
| stative | having, spatial relations, etc. | STATIVE |

From the above it will be apparent that if a syntactic verb structure incudes, for instance, the verb “to buy”, the SOM structure POSSESSION of FIG. 3 will be the matched pre-defined semantic pattern. As another example, if a syntactic verb structure incudes the verb “to walk”, the SOM structure MOTION of FIG. 6 will be the matched pre-defined semantic pattern. After each SOM structure is identified, the Matching (selecting) will look for its associated concepts from the dependency relations. For example, the sentence “A library issues loan items to customers” is a Possession SOM that is associated with the following concepts: a Possession action (issues), a source Agent (library), a Key Object (loan items), and a destination Agent (customers). These concepts are extracted from the dependency relations in this statement: dobj (issues, loan items), nsubj (issues, library) and prep_to (issues, customers).

At a creating instances block 1106, the processor 102 creates a group of SOM instances (SOMis) comprising a semantic pattern instance or SOM Instance (SOMi) for each matching semantic pair. Each semantic pattern instance is of a structure that has elements (locations or positions) for words that form the respective verb structure of the instance. Each semantic pattern instance is created based on verb structure translation rules that include identifying an agent component of the matching semantic pattern pair. The Verb Structure Translation (VST) rules are stored in the rule set store 114 and comprise the following rule group that includes the following rules:
VST RULE 1—is a semantic rule that identifies the agent component from a syntactic verb structure as an entity that initiates or performs an action;
VST RULE 2—is a syntactic active tense rule that identifies a said agent component from syntactic verb structure as an entity that initiates or performs an action;
VST RULE 3—is syntactic active tense rule that identifies the agent component from open clausal complement in a syntactic verb structure as an entity that initiates or performs an action;
VST RULE 4—is a syntactic active tense rule that identifies the agent component from a noun phrase that is an object of a verb in a syntactic verb structure;
VST RULE 5—is a rule specific to the SOM structure COMMUNICATION of FIG. 8 and identifies and assigns a noun introduced by the prepositions “for”, “about” and “with” as a key-object within the SOMi;
VST RULE 6—is a syntactic passive tense rule that identifies and assigns a complement introduced by the preposition “by” as a candidate for the role as agent in a SOMi;
VST RULE 7—is a syntactic passive tense rule which identifies a syntactic subject of a passive tense clause as a key-object within the SOMI;
VST RULE 8—is a syntactic rule specific to both the SOM structure COMMUNICATION of FIG. 8 and the SOM structure POSSESSION of FIG. 3, the rule assigns a prepositional modifier of a verb as either a candidate for a source or destination agent within the SOMi; and
VST RULE 9—is a syntactic rule in which any verb prepositional modifier not identified or assigned by any one of the VST RULES 2 to 8 are assigned roles as including Instrument, Object, Container, Material depending on the respective matched pre-defined semantic pattern or SOM.

After the creating of the group of SOMis at the block 1106, a mode test is performed at block 1107 to determine which instance mode of IM1, IM2 or IM3 has been previously selected by a user. Typically, instance mode of IM1 is set by default. Thus, if the method is operating in an instance mode IM1 the method at a block 1108 performs identifying missing information, in at least one of the semantic pattern instances or SOMis. Then, at a block 1109, a process of requesting and receiving the missing information at the user interface 104 is performed which includes inserting the missing information (as additional information) into a respective one of the semantic pattern instances SOMi. The missing information is identified as a missing element such as an Agent, Key Object, Object etc. that is required to complete SOM structure. Thus there is some interaction with a user who is guided to insert the missing information in a required format. The requesting and receiving the missing information at the user interface 104 includes the processor 102 selecting a natural language template from the NL template store 110 for a semantic pattern instance. The user interface 104 then displays, in a natural language, a request for the missing information. As will be apparent to a person skilled in the art, the selected natural language template is selected from a set of templates in the NL store 110 which each template in the set is associated with one of the pre-defined semantic patterns. After block 1109, the received missing information is used, at a block 1110, to update the instances (the group of SOMis) and then another mode test block 1111 determines if the method is operating in generating mode GM2 or GM1 as previously set by a user and by default is typically set to GM2.

It should be noted that the creating instances performed at the block 1106, and updating instances of block 1110 are characterised by each semantic pattern instance element being created as a lexeme. Also, the creating of the instances includes selecting any verb in the matching semantic pair that can be converted into an uninflected form, and converting any such verb into its uninflected form.

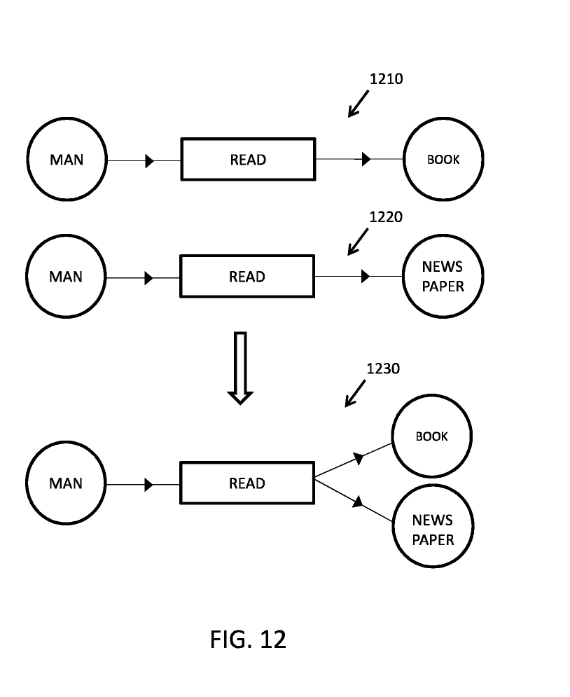

After the group of SOMis is created at block 1106, and if the method 1100 is operating in instance mode IM2, or when operating in modes IM2 and GM2 resulting in the updated group of SOMis being created at block 1110, the processor 102, at a composing block 1112 composes the SOMis into one or more semantic networks or Semantic Object Networks (SONs). An example of composing two semantic pattern instances (SOMi) into a semantic object network (SON) is shown in FIG. 12. As illustrated, a first SOMi 1210 is a SOM structure COGNITION with its Agent set to “man” and Action of “read”. A second SOMi 1220 is also a SOM structure COGNITION with its Agent set to “man” and Action of “read.” Thus the only differences between the first SOMi 1210 and the second SOMi are their Key Objects “book” and “newspaper.” Accordingly, the two SOMis 1210 and 1220 are combined into a SON 1230 (see below for SON) with a single Agent and action that has two resulting Key Objects “book” and “newspaper.”

The composing of SOMi into one or more Semantic Object Networks (SONs) is determined by Structure Composing (CB) rules, based on the structures described in “J. Sowa Conceptual structures: Addison-Wesley, 1984.” These Structure composing (CB) rules are selected from a rule group that includes:
CB Rule 1—only compose semantic pattern instances that are complete;
CB Rule 2—only compose semantic pattern instance elements that have been created as lexemes (including verbs in uninflected form);
CB Rule 3—if an instance of one concept type (either Thing or Action) appears in many SOMs, then all the information related to that instance is gathered under one key, which is the lemma of that instance;
CB Rule 4—a clause is introduced by a subordinating conjunction, such as “if” or “when”, then its position in the text is recorded and the clause itself is recorded as a constraint;
CB Rule 5—if a constrain in the NLR descriptions contains a SOMi, then the constraint will be linked to the SOMi; and
CB Rule 6—if two or more SOMi are positioned in a valid SON behaviour pattern then the resulting pattern behaviour is attached to those SOMi.

At an identifying block 1113, at least one incomplete part of the semantic network (SON) is searched by traversing the semantic network SON in a modified depth first search. The depth first search is illustrated in the following algorithm:

```
MDFS(SON,v):
    label v as explored
    if v is KeyObject then
      all edges become validEdges
    for all validEdges e in
G.adjacentValidEdges(v) do
    if validEdge e is unexplored then
      w ← G.adjacentVertex(v,e)
      if vertex w is unexplored then
        label e as a discovery edge
        recursively call DFS(G,w)
      else
        label e as a back edge.
```

After the SON has been traversed and identifies an incomplete part of the semantic network or SON, a block 1114 performs requesting and receiving additional information to complete the incomplete part of the semantic network. The requesting and receiving is via the user interface 104 and the requesting uses templates in the Natural Language (NL) template store 110 to request the additional information. The requesting and receiving is via the user interface 104 and the requesting uses templates in the natural language template store 110 to request the additional information. Once the additional information is received, an adding block 1116, adds at least one new semantic pattern instance SOMi to the SON to create a revised semantic network.

If the method is operating in instance mode IM1, and generating mode GM1, the new semantic pattern instance or SOMi includes the updated instances of block 1110 which are based on the additional information provided at block 1109. Thus, after the semantic pattern instance or instances are added it is the updated group of instances that can be used to generate an analysis model. Accordingly, at a generating block 1118, an analysis model such as a SOM, SON or UML class diagram is generated from the updated group of instances. The generating of the UML class diagram/model is performed by mapping each semantic pattern instance SOMi in the updated group of instances to an analysis model template obtained from the UML template store 112, to form a mapped pattern. Each mapped pattern is then composed into a coherent class UML model. The generated analysis model is output to the user interface 104 which can include at least a printer, display screen, mouse, touchpad, touch screen or keypad.

In contrast to the above when the method is operating in GM2 mode the generating block 1118 uses the algorithm on the revised network SON that includes the updated instances provided by block 1114. Thus the generating of an analysis model can be from either the revised semantic network. or from the group of instances.

A mapping algorithm of the generating block 1118 is guided by Mapping rules (GS) that assist in matching elements of SOMi or SON to analysis model elements. This algorithm is as follows:

Algorithm 2 Generating Analysis model

| | |
|---|---|
| 1. | AnalysisModel ← empty |
| 2. | for all SOMi ∈ Group Of Instances do |
| 3. | get verb category of the SOMi |
| 4. | if verb.Category matches Template then |
| 5. | for all nodes ∈ SOMi do |
| 6. | if mapping_rules (GS) = TRUE then |
| 7. | Template.element ← SOMi.node |
| 8. | Add Template.element in AnalysisModel |
| 9. | end if |
| 10. | end for |
| 11. | end if |
| 12. | end for |

The Mapping rules (GS) specifically for generating a UML class diagram, for the above diagram, are provided below, However for other analysis models it will apparent that different rules are required.
GS Rule 1—All Thing concepts (e.g., Agent, Key Object, Material, Container, Instrument, and Object) are UML class concept, such that, Class name is equals to the Thing;
GS Rule 2—If an Agent performs Action “A” and “A” affects a Key Object then “A” is a class operation, such that, the operation name is the Action name and return type is the Key Object class, if and only if there is a mapping between Agent and Class;
GS Rule 3—If there is a Thing that has a Property (p), then p is an attribute of a class, such that, the attribute name and type are derived from p, if and only if there is a mapping between Thing and Class;
GS Rule 4—If an Agent(x) performs an Action and an Action affects Key Object(y), then the relation is a Navigable association, such that the member-end class is x, owned-end class is y and association label is the Action name;
GS Rule 5—If there is an Object(x) that modifies a Key Object(y), then the relation is a Navigable association, such that member-end class is x and owned-end class is y;
GS Rule 6—If a Container(x) contains a Key Object(y), then the relation is an Aggregation association, such that the member-end class is x and owned-end class is y;
GS Rule 7—If a Material(x) makes a Key Object(y), then the relation is a Composition association, such that the member-end class is x and owned-end class is y;
GS Rule 8—If an Agent(x) uses an Instrument(y), then the relation is a Dependency relation-ship, such that the supplier class is x and the client class is y;
GS Rule 9—If there is an Action(a) that involves Agent(x) and Agent(y), then the relation is a Dependency relationship, such that the supplier class is x and client class is y; and
GS Rule 10—If a Thing(y) is-of-type Thing(x), then there is a Generalization relationship, such that a general class is x and a classifier class is y.

In contrast to the above when the method is operating in GM1 mode or IM3 mode, the generating block 1118 uses modified algorithms on the final group of SOME created at block 1106 or the updated group of instances provided by block 1110. Thus the generating of an analysis model can be from either the revised semantic network. or from a group of instances.

Advantageously the present invention allows for a NLR descriptions to be transformed into an analysis model with a reduced input from software analysts. This is because the present invention guides the user to input specific additional information that is identified by the SOMis and SONs. The present invention may be suitable for assisting in providing traceability between NLR descriptions and software models, detecting inconsistencies between NLR descriptions or creating natural languages.

1. A method for transforming Natural Language Requirement descriptions into an analysis model, the method being performed by a computer system and the method comprising:
parsing the Natural Language Requirement descriptions to generate syntactic verb structures;
matching each one of the syntactic verb structures with a pre-defined semantic pattern to thereby identify a matching semantic pair for each of the syntactic verb structures, wherein each pre-defined semantic pattern is from a set of pre-defined semantic patterns based on verb categories;
creating a group of instances comprising a semantic pattern instance for each said matching semantic pair, wherein each semantic pattern instance has elements for words contained in the generated syntactic verb structures;
composing the group of instances into at least one semantic network;
identifying at least one incomplete part of the semantic network;
requesting and receiving additional information to complete the incomplete part of the semantic network;
adding at least one new semantic pattern instance to the semantic network to create a revised semantic network, wherein the new semantic pattern instance is based on the additional information; and
generating an analysis model from the revised semantic network.

2. The method as claimed in claim 1, wherein the parsing also identifies lexical patterns and lexical labels within the syntactic verb structures.

3. The method as claimed in claim 1, wherein the verb categories are used by the matching to identify the matching semantic pattern for each of the syntactic verb structures.

4. The method as claimed in claim 1, wherein each said semantic pattern instance is created based on verb structure translation rules that identify an agent component of the matching semantic pattern pair, wherein the verb structure translation rules are selected from a rule group that includes: a semantic rule that identifies a said agent component from words in a syntactic verb structure as entities that perform an action; a syntactic rule that identifies a said agent component that initiates or performs an action from a syntactic verb structure; an external subject rule that identifies a said agent component that perform an action from a syntactic verb structure; and a direct object of a verb phrase rule that identifies a said agent component from a noun phrase that is an object of a verb in a syntactic verb structure.

5. The method as claimed in claim 1, wherein the creating includes identifying missing information in at least one of the semantic pattern instances, requesting and receiving the missing information at a user interface of the system, and inserting the missing information into a respective one of the semantic pattern instances.

6. The method as claimed in claim 1, wherein the requesting and receiving the missing information at a user interface includes selecting a natural language template for a semantic pattern instance and displaying in a natural language a request for the missing information, wherein the template is selected from a set of templates in which each template in the set is associated with one of the pre-defined semantic patterns.

7. The method as claimed in claim 1, wherein the creating is characterised by each semantic pattern instance element is created as a lexeme.

8. The method as claimed in claim 1, wherein the creating includes selecting any verb in the matching semantic pair that can be converted into an uninflected form, and converting any such verb into its uninflected form.

9. The method as claimed in claim 1, wherein the composing is determined by rules that are selected from a rule group that includes: only composing semantic pattern instances that are complete; and only composing semantic pattern instances that have a verb in an uninflected form.

10. The method as claimed in claim 1, wherein the identifying includes traversing the semantic network in a modified depth first search to identify at least one incomplete part of the network.

11. The method as claimed in claim 10, wherein the modified depth first search is guided by a set of rules that indicate the incomplete part as a sub-network.

12. The method as claimed in claim 1, wherein the generating includes:
mapping the elements of the revised semantic network to analysis model elements.

13. The method as claimed in claim 1, wherein the generating includes outputting the analysis model to the user interface.

14. A computer system that in operation performs the method as claimed in claim 1.

15. A tangible computer-readable medium storing instructions for performing the method as claimed in claim 1.

16. A method for transforming a Natural Language Requirement descriptions into an analysis model, the method being performed by a computer system and the method comprising:
parsing the Natural Language Requirement descriptions to generate syntactic verb structures from the natural language;
matching each one of the syntactic verb structures with a pre-defined semantic pattern to thereby identify a matching semantic pair for each of the syntactic verb structures, wherein each pre-defined semantic pattern is from a set of pre-defined semantic patterns based on verb categories;
creating a group of instances comprising a semantic pattern instance for each said matching semantic pair, wherein each semantic pattern instance has elements for words that form the respective verb structure of the instance; and
generating an analysis model from the group of instances.

17. The method as claimed in claim 16, wherein the parsing also identifies lexical patterns and lexical labels within the syntactic verb structures.

18. The method as claimed in claim 16, wherein the verb categories are used by the matching to identify the matching semantic pattern for each of the syntactic verb structures.

19. The method as claimed in claim 16, wherein each said semantic pattern instance is created based on verb structure translation rules that identify an agent component of the matching semantic pattern pair, wherein the verb structure translation rules are selected from a rule group that includes: a semantic rule that identifies a said agent component from words in a syntactic verb structure as entities that perform an action; a syntactic rule that identifies a said agent component that initiates or performs an action from a syntactic verb structure; an external subject rule that identifies a said agent component that perform an action from a syntactic verb structure; and a direct object of a verb phrase rule that identifies a said agent component from a noun phrase that is an object of a verb in a semantic verb structure.

20. The method as claimed in claim 16, wherein the creating includes identifying missing information in at least one of the semantic pattern instances, requesting and receiving the missing information at a user interface of the system, and inserting the missing information into a respective one of the semantic pattern instances to form an updated group of instances.

21. The method as claimed in claim 16, wherein the generating includes:
mapping each semantic pattern instance in the updated group of instances to an analysis model template to form a mapped pattern; and
composing each mapped pattern into a coherent class model.

22. The method as claimed in claim 16, wherein the creating is characterised by each semantic pattern instance element is created as a lexeme.

23. The method as claimed in claim 16, wherein the creating includes selecting any verb in the matching semantic pair that can be converted into an uninflected form, and converting any such verb into its uninflected form.

24. The method as claimed in claim 21, wherein the composing is determined by rules that are selected from a rule group that includes: only composing semantic pattern instances that are complete; and only composing semantic pattern instances that have a verb in an uninflected form.
